(19) United States
(12) Patent Application Publication
(10) Pub. No.: US 2019/0232507 A1
(43) Pub. Date: Aug. 1, 2019

(54) Convenient Blade Changeable Knife

(71) Applicant: Hong Ann Tool Industries Co., Ltd., Taichung City (TW)

(72) Inventor: Cheng-Wei SU, Taichung City (TW)

(21) Appl. No.: 16/261,762

(22) Filed: Jan. 30, 2019

(30) Foreign Application Priority Data
Jan. 31, 2018 (TW) 107103478

(51) Int. Cl. B26B 5/00

(52) U.S. Cl. CPC B26B 5/00

(57) ABSTRACT

A blade changeable knife includes a first holding member having a first holding portion and a first connecting portion and a second holding member having a second holding portion and a second connecting portion. The second holding portion and the second connecting portion is interconnected by a flexible portion. The second connecting portion is disposed on the first connecting portion. The second holding portion and the first holding portion are disposed oppositely. The second holding member is adapted to be flexed to a holding position and a releasing position in which the first and the second holding portions are disposed apart from each other. Further, a lock is movably engaged with the second holding member. The lock is disposed at a first position when the second holding member is in the holding position and at a second position when the second holding member is in the releasing position.

### BACKGROUND OF THE INVENTION

### 1. Field of the Invention

The present invention relates to a cutting tool and, particularly, to a knife and, more particularly, to a convenient blade changeable knife.

### 2. Description of the Related Art

U.S. Pat. No. 8,356,415 B2 entitled scraping tool with blade lock assembly shows a scraping tool for allowing a user to quickly assemble and replace a scraper. The scraping tool includes a gripping portion, a scraping portion, an arm extending from a jaw clamp, and a fastener to be located inside a groove in the back of the scraping section. The fastener is used as a pivot for the arm. The arm can swing back and forth. Further, a control button is operable to force the jaw clamp to frictionally hold a scraper blade.

It is found that the scraping tool has a complex structure. Further, the jaw clamp is not widely open when the scraper blade is replaced, so it is inconvenient to replace the scraper blade. Further, the scraper blade comes off the jaw clamp easily when it is subject to a force that overwhelms the friction therebetween.

The present invention is, therefore, intended to obviate or at least alleviate the problems encountered in the prior art.

### SUMMARY OF THE INVENTION

According to the present invention, a convenient blade changeable knife includes a first holding member and a second holding member. The first holding member has a first holding portion and a first connecting portion. The second holding member has a second holding portion and a second connecting portion. The second holding portion and the second connecting portion are interconnected by a flexible portion such that the second holding portion is adapted to be flexed with respect to the second connecting portion. The second connecting portion is disposed on and connected with the first connecting portion. The second holding portion and the first holding portion are disposed oppositely and configured to hold a blade therebetween. The second holding member is adapted to be flexed to a holding position in which the first and the second holding portions are disposed close to each other and include a space therebetween for receiving the blade and a releasing position in which the first and the second holding portions are disposed apart from each other.

The convenient blade changeable knife also includes a locking device having a lock movably engaged with the second holding member. When the second holding member is in the holding position, the lock is disposed on and abuts the second holding member at a first position. When the second holding member is in the releasing position, the lock is disposed on and abuts the second holding member at a second position further away from the second holding portion than when in the first position.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a blade changeable knife in accordance with a first embodiment of the present invention.

FIG. 2 is an exploded perspective view of the blade changeable knife of FIG. 1.

FIG. 3 is a cross-sectional view of the blade changeable knife of FIG. 1 in a blade locked position.

FIG. 4 is a cross-sectional view of the blade changeable knife of FIG. 1 in a blade unlocked position.

FIG. 5 is a perspective view of a blade changeable knife in accordance with a second embodiment of the present invention.

FIG. 6 is an exploded perspective view of the blade changeable knife of FIG. 5.

FIG. 7 is a cross-sectional view of the blade changeable knife of FIG. 5 in a blade locked position

FIG. 8 is a cross-sectional view of the blade changeable knife of FIG. 5 in a blade unlocked position.

FIG. 9 is a perspective view of a blade changeable knife in accordance with a third embodiment of the present invention.

FIG. 10 is an exploded perspective view of the blade changeable knife of FIG. 9.

FIG. 11 is a cross-sectional view of the blade changeable knife of FIG. 9 in a blade locked position.

FIG. 12 is a cross-sectional view of the blade changeable knife of FIG. 9 in a blade unlocked position.

### DETAILED DESCRIPTION OF THE INVENTION

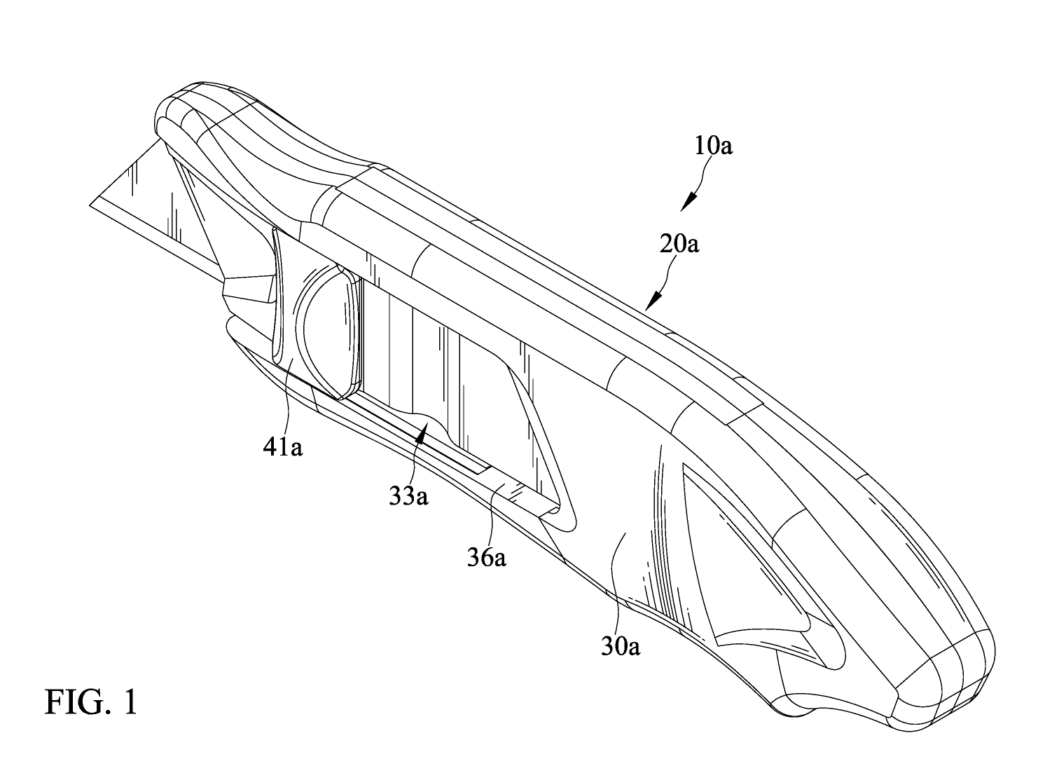

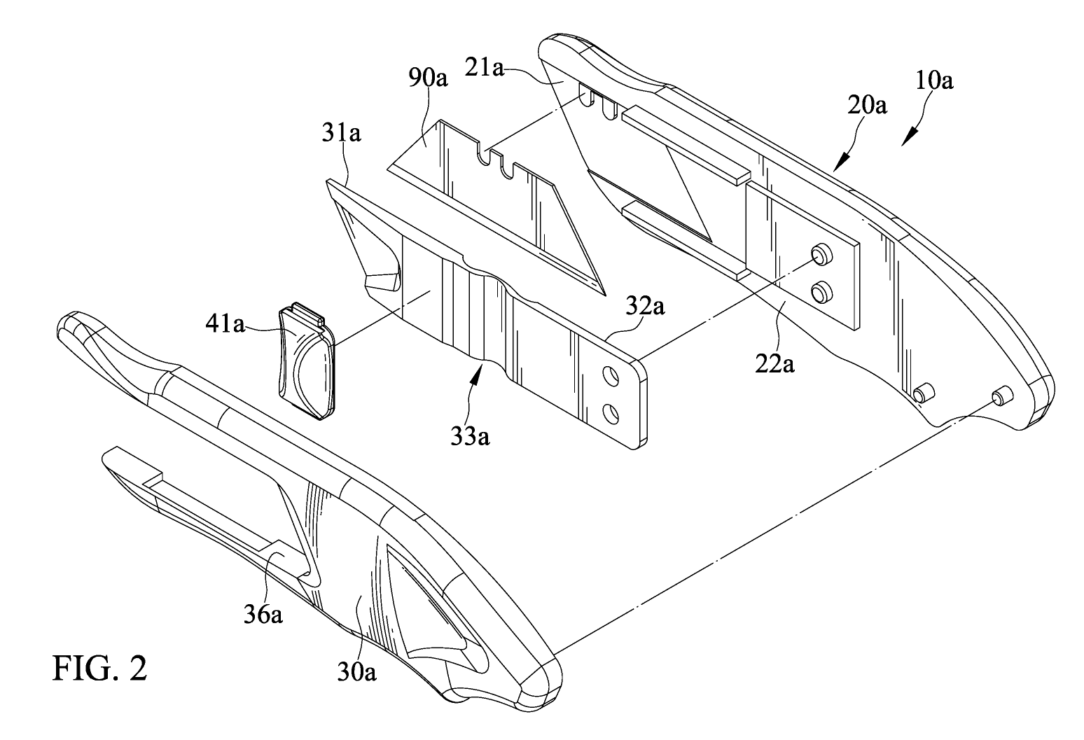

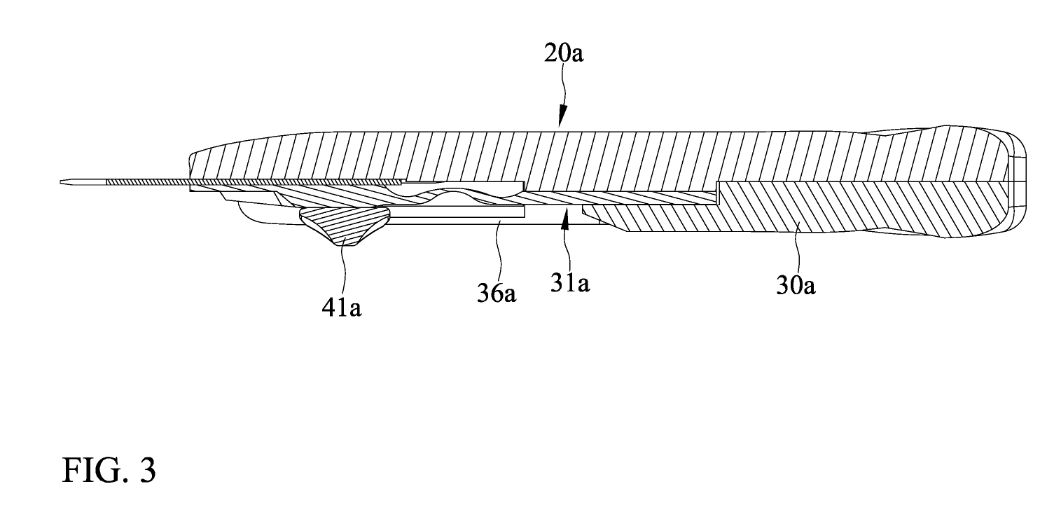

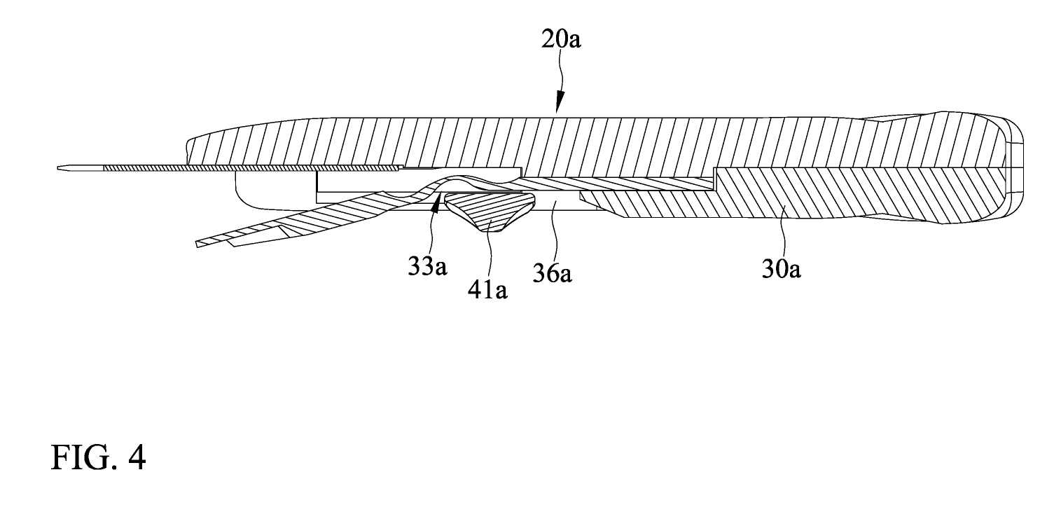

FIGS. 1 through 4 show a blade changeable knife 10a in accordance with a first embodiment of the present invention. The blade changeable knife 10a has a holding member 20a and a holding member 30a configured to hold a blade 90a.

The holding member 20a has a holding portion 21a and a connecting portion 22a.

The holding member 30a has a holding portion 31a and a connecting portion 32a. The connecting portion 32a is disposed on and connected with the connecting portion 22a. The holding portion 31a and the connecting portion 32a are interconnected by a flexible portion 33a such that the holding portion 31a is adapted to be flexed with respect to the connecting portion 32a.

The holding member 30a is adapted to be flexed to a holding position in which the holding portions 21a and 31a are disposed close to each other and include a space therebetween for receiving the blade 90a and a releasing position in which the holding portions 21a and 31a are disposed apart from each other. The flexible portion 33a extends curvedly longitudinally. The flexible portion 33a is thinner than the holding portion and the connecting portion. The holding member 30a has a first holding component and a second holding component coupled to the first holding component. The first holding component defines a slot 36a. The second holding component is held between the first holding component and the holding member 20a.

Further, the blade changeable knife 10a has a locking device. The locking device has a lock 41a movably engaged with the holding member 30a. The lock 41a is movably engaged in the slot 36a. The lock 41a is selectively disposed on the second holding portion 31a and the second connecting portion 32a. When the holding member 30a is in the holding position, the lock 41a abuts the holding member 30a, is located at a first position, and is disposed on the holding portion 31a. When the holding member 30a is in the releasing position, the lock 41a abuts the holding member 30a, is located at a second position further away from the holding portion 31a than when in the first position, and is disposed on the connecting portion 32a.

In this embodiment, there is no groove with which the lock 41a engages.

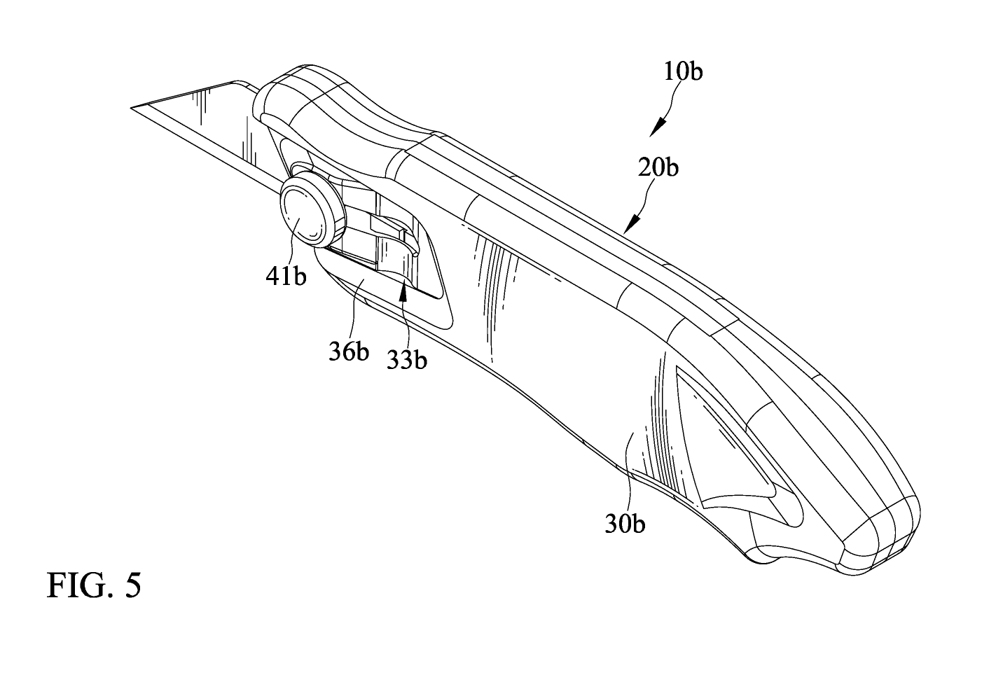

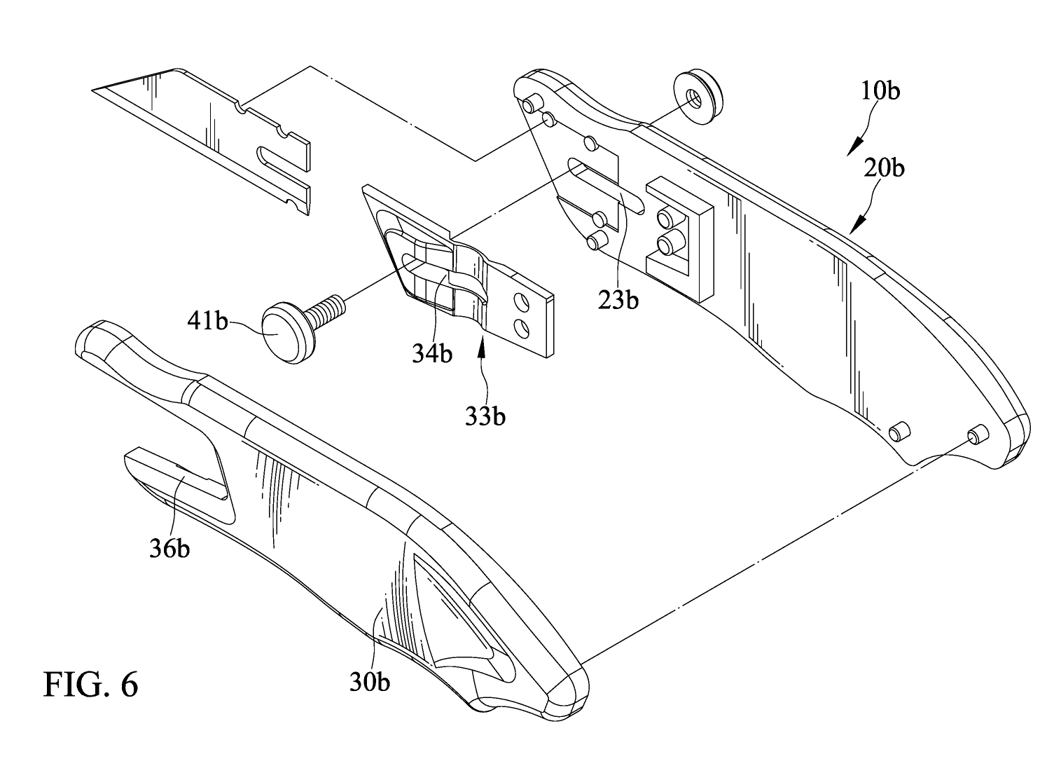

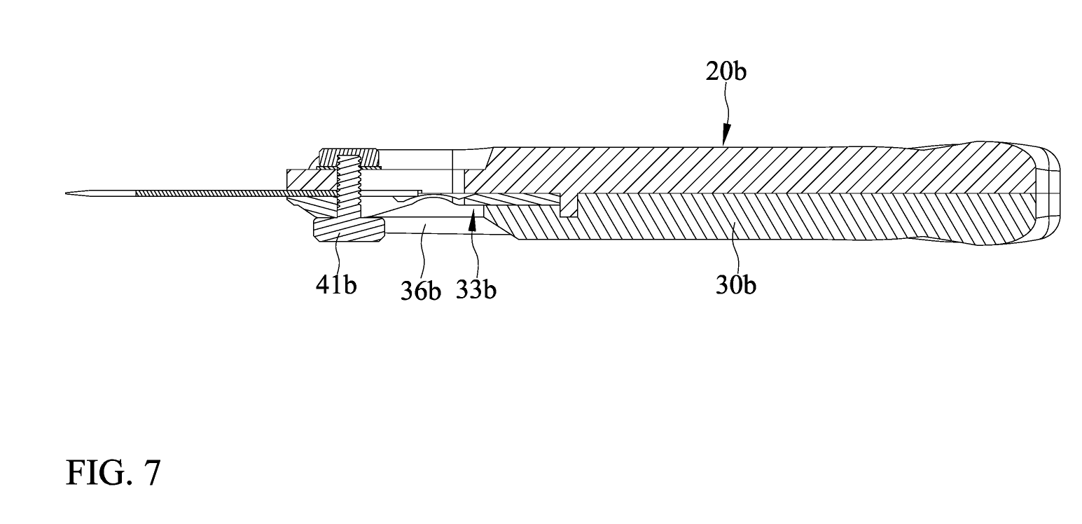

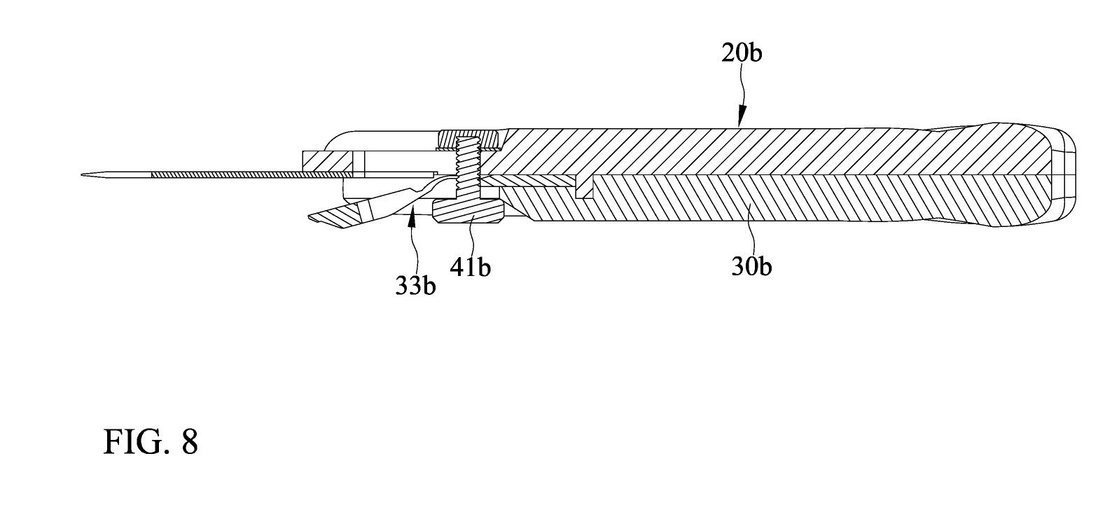

FIGS. 5 through 8 show a blade changeable knife 10b in accordance with a third embodiment of the present invention, and the same numbers are used to correlate similar components of the first embodiment, but bearing a letter b. The blade changeable knife 10b has a holding member 20b and a holding member 30b.

The holding member 20b differentiates from the holding member 20a in that the holding member 20b defines a groove 23b.

The holding member 30b has a holding portion and a connecting interconnected by a flexible portion 33b. The flexible portion 33b extends curvedly longitudinally. The flexible portion 33b is thinner than the holding portion and the connecting portion. The holding member 30b has a first holding component and a second holding component coupled to the first holding component. The first holding component defines a slot 36b. The holding member 30b differentiates from the holding member 30a in that the holding member 30b defines a groove 34b. The groove 34b is defined in the second holding component. The second holding component is held between the first holding component and the holding member 20b.

Further, the blade changeable knife 10b has a locking device. The locking device has a lock 41b movably engaged in the groove 34b. The locking device has a fastener engaged with the lock 41b. The lock 41b has an engaging portion movably engaged in the groove 34b and the groove 23b. The engaging portion has an end disposed outside of the second groove 23b and engaged with the fastener. The lock 41b is movably engaged in the slot 36b.

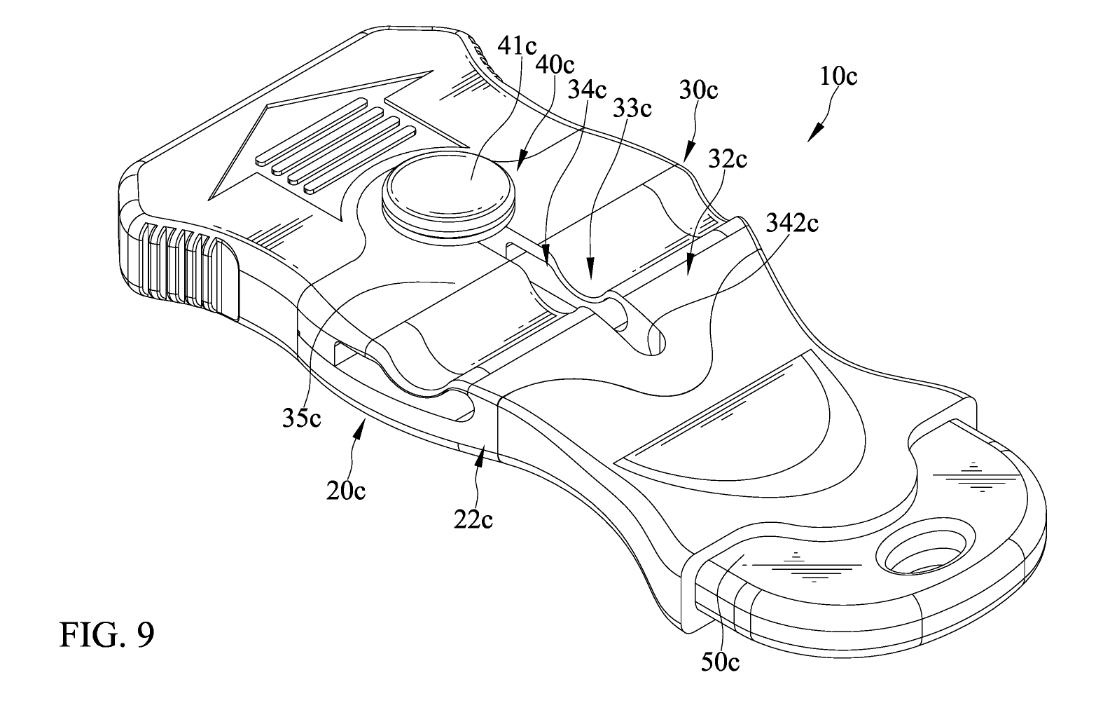

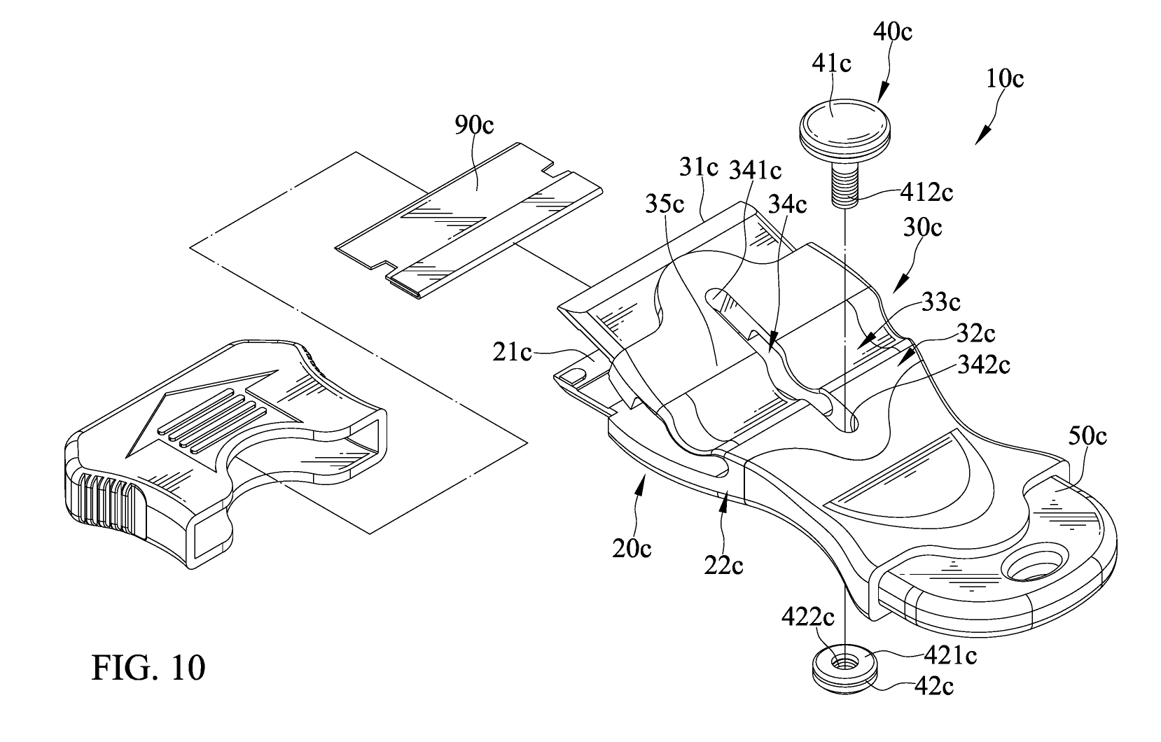

FIGS. 9 through 12 show a blade changeable knife in accordance with a second embodiment of the present invention, and the same numbers are used to correlate similar components of the first embodiment, but bearing a letter c. The holding member 20c has a holding portion 21c and a connecting portion 22c. The holding member 20c defines a groove 23c. The groove 23c has an end 231c and an end 232c.

The holding member 30c has a holding portion 31c and a connecting portion 32c. The holding member 30c is formed in one piece. The holding portion 31c and the holding portion 21c are disposed oppositely and configured to hold the blade 90c therebetween. The connecting portion 32c is disposed on and connected with the connecting portion 22c. The holding portion 31c and the connecting portion 32c are interconnected by a flexible portion 33c such that the holding portion 31c is adapted to be flexed with respect to the connecting portion 32c. The holding member 30c is adapted to be flexed to a holding position in which the holding portions 21c and 31c are disposed close to each other and include a space therebetween for receiving the blade 90c and a releasing position in which the holding portions 21c and 31c are disposed apart from each other. The flexible portion 33c extends curvedly longitudinally. The flexible portion 33c is thinner than the holding portion 31c and the connecting portion 32c. The holding member 30c defines a groove 34c. The groove 34c extends longitudinally in the holding portion 31c and the flexible portion 33c.

Further, a locking device 40c has a lock 41c movably engaged with the holding member 30c. The lock 41c is selectively disposed on the holding portion 31c and the connecting portion 32c. When the holding member 30c is in the holding position, the lock 41c abuts the holding member 30c, is located at a first position, and is disposed on the holding portion 31c. The lock 41c has an abutting portion 411c movably disposed on an outer surface 35c of the holding member 30c. When the holding member 30c is in the releasing position, the lock 41c abuts the holding member 30c, is located at a second position further away from the holding portion 31c than when in the first position, and is disposed on the connecting portion 32c. The lock 41c is movably engaged in the groove 34c. The locking device 40c has a fastener 42c engaged with the lock 41c. The groove 34c has an end 341c defined in the holding portion 31c, a middle defined in the flexible portion 33c, and an end 342c defined in the connecting portion 32c respectively. The lock 41c has an engaging portion 412c movably engaged in the grooves 34c and 23c. The engaging portion 412c has an end disposed outside of the groove 23c and engaged with the fastener 42c. The fastener 42c has an engaging portion 422c. The lock 41c includes the engaging portion 412c thereof engaged with the engaging portion 422c of the fastener 42c. The lock 41c and the fastener 42c are in thread engagement. The fastener 42c has an abutting portion 421c movably disposed on an outer surface 24c of the holding member 20c.

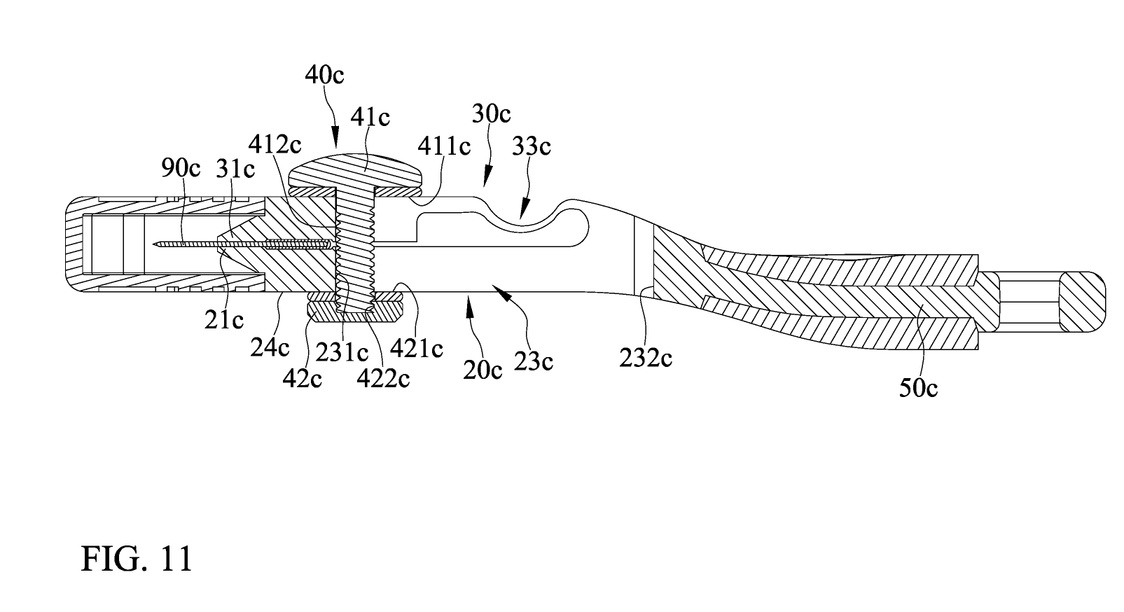

FIG. 11 shows the blade changeable knife 10c in a blade locked position in which the holding member 30c is in the holding position and the lock 41c is located at the first position. When the holding member 30c is in the holding position, the lock 41c is located adjacent to the end 341c of the groove 34c and the end 231c of the groove 23c.

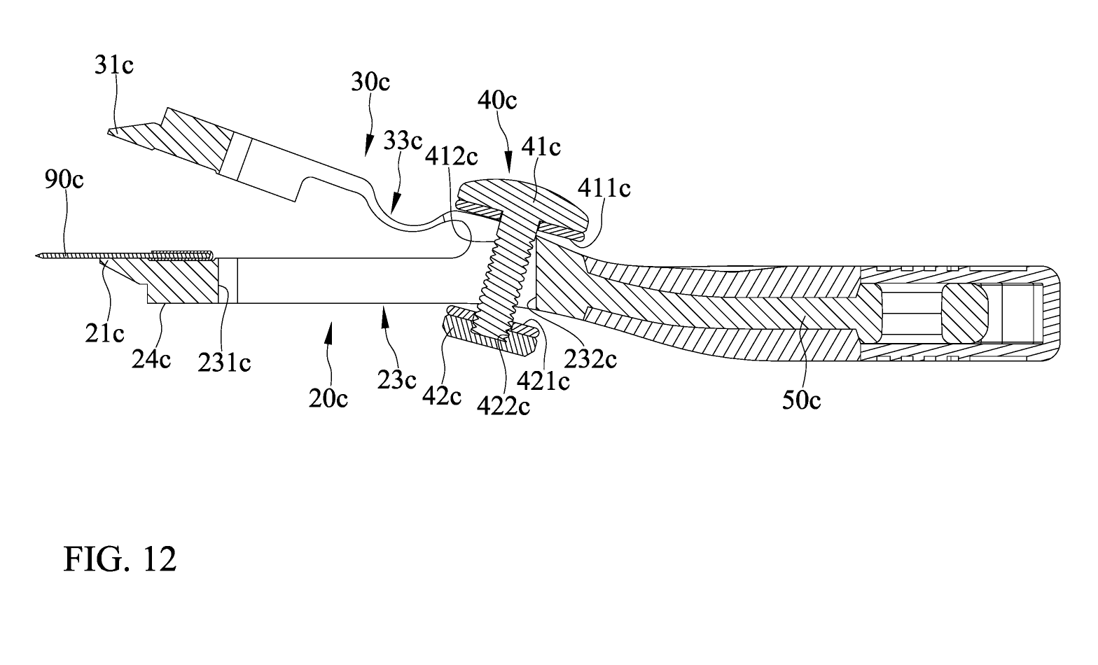

FIG. 12 shows the blade changeable knife 10c in a blade unlocked position in which the holding member 30c is in the releasing position and the lock 41c is located at the second position. When the holding portions 21c and 31c are disposed apart from each other, a user can replace the blade 90c. Further, since the holding portion 31c is adapted to be flexed with respect to the connecting portion 32c, the holding portion 31c can be moved further apart from the holding portion 21c to enable the user to replace the blade 90c conveniently. When the holding member 30c is in the releasing position, the lock 41c is located adjacent to the ends 342c of the groove 34c and the end 232c of the groove 23c.

The blade changeable knife 10c also has a grip portion 50c. A user can hold on the grip portion 50c when operating the blade changeable knife 10c. The connecting portions 22c and 32c of the holding members 20c and 30c are connected between the holding portions 21c and 31c of the holding members 20c and 30c and the grip portion 50c. The holding members 20c and 30c and the grip portion 50c are formed in one piece. The holding members 20c and 30c and the grip portion 50c are molded in one piece.

In view of the forgoing, the locking device 40c can be easily operated. Further, the holding portions 21a, 21c, 31a, and 31c can move away from each other to an extent that a user can replace the blades 90a and 90c conveniently when the locking device 40c is moved to the unlocking position.

The foregoing is merely illustrative of the principles of this invention and various modifications can be made by those skilled in the art without departing from the scope and spirit of the invention.

What is claimed is:

1. A blade changeable knife comprising:
a first holding member having a first holding portion and a first connecting portion;
a second holding member having a second holding portion and a second connecting portion, wherein the second holding portion and the second connecting portion are interconnected by a flexible portion such that the second holding portion is adapted to be flexed with respect to the second connecting portion, wherein the second connecting portion is disposed on and connected with the first connecting portion, wherein the second holding portion and the first holding portion are disposed oppositely and configured to hold a blade therebetween, and wherein the second holding member is adapted to be flexed to a holding position in which the first and the second holding portions are disposed close to each other and include a space therebetween for receiving the blade and a releasing position in which the first and the second holding portions are disposed apart from each other; and
a locking device having a lock movably engaged with the second holding member, wherein when the second holding member is in the holding position, the lock abuts the second holding member and is located at a first position, and wherein when the second holding member is in the releasing position, the lock abuts the second holding member and is located at a second position further away from the second holding portion than when in the first position.

2. The blade changeable knife as claimed in claim 1, wherein the lock is selectively disposed on the second holding portion and the second connecting portion, wherein when the second holding member is in the holding position, the lock is disposed on the second holding portion, and wherein when the second holding member is in the releasing position, the lock is disposed on the second connecting portion.

3. The blade changeable knife as claimed in claim 1, wherein the flexible portion extends curvedly longitudinally.

4. The blade changeable knife as claimed in claim 3, wherein the flexible portion is thinner than the second holding portion and the second connecting portion.

5. The blade changeable knife as claimed in claim 1, wherein the second holding member are formed in one piece.

6. The blade changeable knife as claimed in claim 5 further includes a grip portion, wherein the first and the second connecting portions of the first and the second holding members are connected between the first and the second holding portions of the first and the second holding members and the grip portion, and wherein the first and the second holding members and the grip portion are formed in one piece.

7. The blade changeable knife as claimed in claim 5, wherein the flexible portion extends curvedly longitudinally.

8. The blade changeable knife as claimed in claim 7, wherein the flexible portion is thinner than the second holding portion and the second connecting portion.

9. The blade changeable knife as claimed in claim 1, wherein the second holding member defines a first groove, and wherein the lock is movably engaged in the first groove.

10. The blade changeable knife as claimed in claim 9, wherein the first holding member defines a second groove, wherein the locking device has a fastener engaged with the lock, wherein the lock has a first engaging portion movably engaged in the first groove and the second groove, wherein the first engaging portion has an end disposed outside of the second groove and engaged with the fastener.

11. The blade changeable knife as claimed in claim 10, wherein the first groove extends longitudinally in the second holding portion and the flexible portion.

12. The blade changeable knife as claimed in claim 9, wherein the second holding member is formed in one piece.

13. The blade changeable knife as claimed in claim 9, wherein the second holding member has a first holding component and a second holding component coupled to the first holding component, wherein the first holding component defines a slot and the lock is movably engaged in the slot, wherein the first groove is defined in the second holding component, and wherein the second holding component is held between the first holding component and the first holding member.

14. The blade changeable knife as claimed in claim 1, wherein the second holding member has a first holding component and a second holding component coupled to the first holding component, wherein the first holding component defines a slot and the lock is movably engaged in the slot, and wherein the second holding component is held between the first holding component and the first holding member.

15. The blade changeable knife as claimed in claim 14, wherein the flexible portion extends curvedly longitudinally.

16. The blade changeable knife as claimed in claim 15, wherein the flexible portion is thinner than the second holding portion and the second connecting portion.

17. The blade changeable knife as claimed in claim 16, wherein the lock is selectively disposed on the second holding portion and the second connecting portion, wherein when the second holding member is in the holding position, the lock is disposed on the second holding portion, and wherein when the second holding member is in the releasing position, the lock is disposed on the second connecting portion.
